(19) United States
(12) Patent Application Publication
(10) Pub. No.: US 2025/0284266 A1
(43) Pub. Date: Sep. 11, 2025

(54) System and Method for Fabricating a Part from a Workpiece

(71) Applicant: Brett Bond, Summit, NJ (US)

(72) Inventor: Brett Bond, Summit, NJ (US)

(21) Appl. No.: 18/600,885

(22) Filed: Mar. 11, 2024

(51) Int. Cl. G05B 19/4099; G05B 19/18

(52) U.S. Cl. CPC G05B 19/4099; G05B 19/182; G05B 2219/49023

(57) ABSTRACT

A system and a method for fabricating a part from a workpiece using a cutting tool. The method includes receiving a first instructional prompt describing a desired part to be fabricated, and obtaining visual input of the workpiece to be cut. The method further includes, using the visual input, determining a location, size, and shape of the workpiece relative to the cutting tool. The method further includes generating a three-dimensional model matching the description in the first instructional prompt, based on previously obtained training data. A cutting routine is then generated based on the three-dimensional model and on the determined location, size, and shape of the workpiece relative to the cutting tool. Finally, the method includes causing execution of the cutting routine so as to cut workpiece to fabricate the desired part.

### FIELD OF THE DISCLOSED TECHNOLOGY

The disclosed technology relates generally to methods of fabricating a part having a three-dimensional shape from a workpiece, and, more specifically, to a method and a system for automatically generating instructions to precisely cut the workpiece into the desired part having the desired three-dimensional shape.

### BACKGROUND OF THE DISCLOSED TECHNOLOGY

Cutting machines, such as computer numerical control (CNC) machines, are precision machines capable of accurately manipulating (e.g. cutting, bending, etching, 3d printing) a workpiece, based on specifications and parameters provided to a machine via a computer.

In the prior art, in order to achieve accurate, repeatable CNC-machined parts that comply with design tolerances, it is commonly necessary to specify a large number of parameters for each machining operation, typically using Computer Aided Manufacturing (CAM) software. These parameters may include the material's physical position relative to a work coordinate system offset defined in the machine's control software, such as “G54,” the default work coordinate offset commonly used in G-Code-based systems. The complete set of required parameters supplied to the CAM software, can then be used to generate CNC machine control commands, for example G-Code. However, generation of such G-Code can be complicated and require much training and experience.

At the CNC machine, the machinist positions and fixes the material to the worktable and sets the coordinates, telling the CNC machine where to start a cut. The position of the material on the worktable, if needed, is then compensated for in the CNC controller's software, such as by modifying the coordinates of the work offset. In practice, alignment and fixturing of the workpiece often involves several time-consuming corrective steps, particularly for novice CNC machinists. Often, modifications to the CAD model, the CAM toolpath, the output G-Code, the CNC controller work offsets, the material itself, and possibly all of the above, are made before activating the machine to produce an in-tolerance part.

In addition to workpiece positional parameters and their adjustment, many other parameters must often be modified and refined to obtain acceptable CNC performance. Adjustment of such parameters requires skilled operator time, often consume extra material for test passes, can result in damage to parts, damage to tools, and occasionally damage to the CNC equipment itself.

There is thus a need in the art for a method and a system for a user to easily generate CAM instructions, such as G-Code, for cutting a workpiece, and for simple and precise cutting of the workpiece using that G-Code, in order to quickly produce high-precision results.

### SUMMARY OF THE DISCLOSED TECHNOLOGY

The disclosed technology provides a method and a system for automatically generating instructions to precisely cut a workpiece into a desired part having a desired three-dimensional shape, and for cutting the workpiece in accordance with the instructions.

In accordance with the disclosed technology, a user provides an audible or textual instructional prompt to a computer populated with training data, for cutting a desired part from a workpiece. The computer is also provided with a visual input of the workpiece to be cut, which is used to determine parameters of the workpiece, such as a location, a size, and a shape of the workpiece, relative to a cutting tool associated with the computer.

Based on the training data and the visual input, the computer generates a three-dimensional model of the desired part, matching the instructional prompt, and then generates a series of CAM instructions for cutting the desired part out of the workpiece, based on the generated three-dimensional model and the determined parameters. Finally, the computer causes the cutting tool to cut the workpiece based on the generated series of CAM instructions.

In some embodiments, the three-dimensional model may be outputted, visually, to the user, enabling the user to manipulate or modify the three-dimensional model by providing an additional instructional prompt to the computer. In some embodiments, the additional instructional prompt may also be used to modify the training data.

In some other embodiments, following visual outputting of the three-dimensional model to the user, the user may provide a confirmation input, confirming suitability or shape of the generated three-dimensional model. In some such embodiments, the generated three-dimensional model and/or the training data typically remain unchanged.

In some embodiments, the instructional prompt may relate to a shape of the desired part, such as a polygon.

In some embodiments, the instructional prompt may relate to one or more physical properties of the workpiece, such as dimensions, locations within the workpiece, and the like.

In some embodiments, the instructional prompt may include a description of a visual feature of the workpiece, and a task to be performed on, or relative to, the visual feature of the workpiece. For example, the visual feature may be crack or a permanent break in the workpiece, and the task to be performed may be a task of fixing the crack or permanent break.

In some embodiments, the instructional prompt may include a description of a real-world object with a linguistic modifier, as well as a style of a second real-world object. For example, the instructional prompt may specify that a workpiece is to be cut into the shape of a circular coaster and should include a decorate element on its surface of a Staunton chess piece, so that the coaster will include engravings of a style that matches a depth or shape of engravings in such chess pieces.

In some embodiments, the instructional prompt includes instructions for preparing the workpiece to interact with a second workpiece. For example, the instructional prompt may include instructions to cut a dovetail into the workpiece for joining with a dovetail of a second workpiece.

In accordance with an aspect of the disclosed technology, there is provided a method for fabricating a part from a workpiece using a cutting tool. The method includes receiving a first instructional prompt describing a desired part to be fabricated, and obtaining visual input of the workpiece to be cut. The method further includes, using the visual input, determining a location, size, and shape of the workpiece relative to the cutting tool. The method further includes generating a three-dimensional model matching the description in the first instructional prompt, based on previously obtained training data. A cutting routine is then generated based on the three-dimensional model and on the determined location, size, and shape of the workpiece relative to the cutting tool. Finally, the method includes causing execution of the cutting routine so as to cut workpiece to fabricate the desired part.

In some embodiments, the method further includes visually outputting a representation of the three-dimensional model to a user.

In some embodiments, the method further includes, following visually outputting and prior to generating the cutting routine, receiving from the user a second instructional prompt including instructions for altering the three-dimensional model, and based on the second instructional prompt, altering at least one of the three-dimensional model and the training data.

In some embodiments, receiving the first instructional prompt includes receiving the first instructional prompt as a text input. In some embodiments, receiving the first instructional prompt includes receiving the first instructional prompt as an audio input.

In some embodiments, the obtained visual input includes at least one glyph, and the determining of the location of the workpiece relative to the cutting tool is based on the location of the at least one glyph.

In some embodiments, the cutting routine includes a cutting routine which is neither explicit in the training data nor explicit in the first instructional prompt.

In some embodiments, the first instructional prompt includes a description of a first real-world object with a linguistic modifier including a style of a second real-world object. In some embodiments, generating of the three-dimensional model includes generating a three-dimensional model which is a unique version of the first real-world object in the style of the second real-world object. In some embodiments, the desired part resulting from cutting by the cutting tool includes a representation of the unique version of the first real-world object.

In some embodiments, the first instructional prompt includes a description of a visual feature of the workpiece and a task to be performed on, or relative to, the visual feature of the workpiece.

In some embodiments, the visual feature is a crack or a break in the workpiece, and the task to be performed includes fixing of the craft or the break in a manner described in the first instructional prompt.

In some embodiments, the task to be performed includes preparing of the workpiece to interface with a second workpiece or part.

In accordance with an aspect of the disclosed technology, there is provided a system for cutting a workpiece using a cutting tool. The system includes a visual input interface, at least one other input interface, and a data storage medium storing training data. The system further includes a processor, functionally associated with the visual input interface, the at least one other input interface, and the data storage medium. The system further includes an instructions storage medium, storing instructions for operation of the processor.

The instructions storage medium has stored instructions to receive from the at least one other input interface a first instructional prompt describing a desired part to be fabricated, and to receive from the visual input interface a visual input of the workpiece to be cut. The instructions storage medium further has stored instructions to use the received visual input to determine a location, size, and shape of the workpiece relative to the cutting tool. The instructions storage medium further has stored instructions to generate a three-dimensional model matching the description in the first instructional prompt, based on the training data and instructions to generate a cutting routine based on the three-dimensional model and on the determined location, size, and shape of the workpiece relative to the cutting tool. The instructions storage medium further has stored instructions to cause the cutting tool to execute the cutting routine so as to cut workpiece to fabricate the desired part.

In some embodiments, the system further includes an output interface, functionally associated with the processor, and the instructions storage medium further has stored instructions for the processor to provide, via the output interface, a visual output of the three-dimensional model, the visual output being perceivable by a user.

In some embodiments the instructions storage medium further has stored instructions to receive from the user a second instructional prompt including instructions for altering the three-dimensional model provided in the visual output, and instructions to alter at least one of the three-dimensional model and the training data based on the second instructional prompt.

In some embodiments, the at least one other input interface includes at least one of a textual interface adapted to capture the first instructional prompt as a text input and an audio interface adapted to capture the first instructional prompt as an audio input.

In some embodiments the visual input includes at least one glyph, and the instructions to determine of the location of the workpiece relative to the cutting tool include instructions to determine the location based on the location of the at least one glyph.

In some embodiments, the instructions to generate the cutting routine include instructions to generate a cutting routine which is neither explicit in the training data nor explicit in the first instructional prompt.

In some embodiments, the first instructional prompt includes a description of a first real-world object with a linguistic modifier including a style of a second real-world object and the instructions to generate the three-dimensional model include instructions to generate a three-dimensional model which is a unique version of the first real-world object in the style of the second real-world object.

In some embodiments, the system further includes the cutting tool.

For purposes of this disclosure “workpiece” is defined as “an object to be cut into”. For example, a workpiece may be formed of wood, plastic, metal or other physical material that may be worked on by CNC machinery.

For purposes of this disclosure “training data” is defined as “a stored dataset mapping input words, geometric points, dimensions and instructions correlated with desired output stylistic designs, 3D geometry and CAM instructions.”

For purposes of this disclosure “manipulation” is defined as “the alteration of orientation, scale, warp, shear, twist, mirror, translation, scale, and/or position of an object”.

For purposes of this disclosure “modification” is defined as “the alteration of the shape of an object”. For example, modification may include increasing or decreasing the number of sides or faces of an object, changing angle measures between sides of the object, or manipulating a subsection of the object.

For purposes of this disclosure “style” is defined as “an ornamental or otherwise non-integral feature of an object, whose presence or lack thereof confers a recognizability of the object for a person of ordinary skill in the art.”

For purposes of this disclosure “crack” is defined as “a discontinuity in geometry.”

For purposes of this disclosure “permanent break” is defined as “a separation of an object into at least two components, where the components of the object cannot substantially be mechanically adjoined”.

“Substantially” and “substantially shown,” for purposes of this specification, are defined as “between and including 90% to 100%,” or as otherwise indicated. “Identical” or “exactly,” for purposes of this specification, is defined as “within an acceptable tolerance level known in the art.” Any device may “comprise,” or “consist of,” the devices mentioned there-in, as limited by the claims. Any element described may be one of “exactly” or “substantially,” as described.

It should be understood that the use of “and/or” is defined inclusively, such that the term “a and/or b” should be read to include the sets: “a and b,” “a or b,” “a,” or “b.”

### BRIEF DESCRIPTION OF THE DRAWINGS

FIG. 1 is a block diagram of a system for cutting into a workpiece in accordance with an embodiment of the disclosed technology.

FIG. 2 is a flowchart of a method of cutting into a workpiece in accordance with an embodiment of the disclosed technology.

FIG. 3 illustrates a step of obtaining a visual input of a workpiece to be cut, in accordance with an embodiment of the disclosed technology.

FIGS. 4A illustrates steps of obtaining parameters of a workpiece to be cut relative to a cutting tool, in accordance with an embodiment of the disclosed technology.

FIG. 4B illustrates further steps of obtaining parameters of a workpiece to be cut relative to a cutting tool, in accordance with an embodiment of the disclosed technology.

FIGS. 5 illustrates a three-dimensional model associated an instructional prompt provided in accordance with embodiments of the disclosed technology.

### DETAILED DESCRIPTION OF EMBODIMENTS OF THE DISCLOSED TECHNOLOGY

In accordance with an aspect of the disclosed technology, there is provided a method for fabricating a part from a workpiece using a cutting tool. The method includes receiving a first instructional prompt describing a desired part to be fabricated, and obtaining visual input of the workpiece to be cut. The method further includes, using the visual input, determining a location, size, and shape of the workpiece relative to the cutting tool. The method further includes generating a three-dimensional model matching the description in the first instructional prompt, based on previously obtained training data. A cutting routine is then generated based on the three-dimensional model and on the determined location, size, and shape of the workpiece relative to the cutting tool. Finally, the method includes causing execution of the cutting routine so as to cut workpiece to fabricate the desired part.

In accordance with an aspect of the disclosed technology, there is provided a system for cutting a workpiece using a cutting tool. The system includes a visual input interface, at least one other input interface, and a data storage medium storing training data. The system further includes a processor, functionally associated with the visual input interface, the at least one other input interface, and the data storage medium. The system further includes an instructions storage medium, storing instructions for operation of the processor.

The instructions storage medium has stored instructions to receive from the at least one other input interface a first instructional prompt describing a desired part to be fabricated, and to receive from the visual input interface a visual input of the workpiece to be cut. The instructions storage medium further has stored instructions to use the received visual input to determine a location, size, and shape of the workpiece relative to the cutting tool. The instructions storage medium further has stored instructions to generate a three-dimensional model matching the description in the first instructional prompt, based on the training data and instructions to generate a cutting routine based on the three-dimensional model and on the determined location, size, and shape of the workpiece relative to the cutting tool. The instructions storage medium further has stored instructions to cause the cutting tool to execute the cutting routine so as to cut workpiece to fabricate the desired part.

Embodiments of the disclosed technology will become clearer in view of the forthcoming description of the figures.

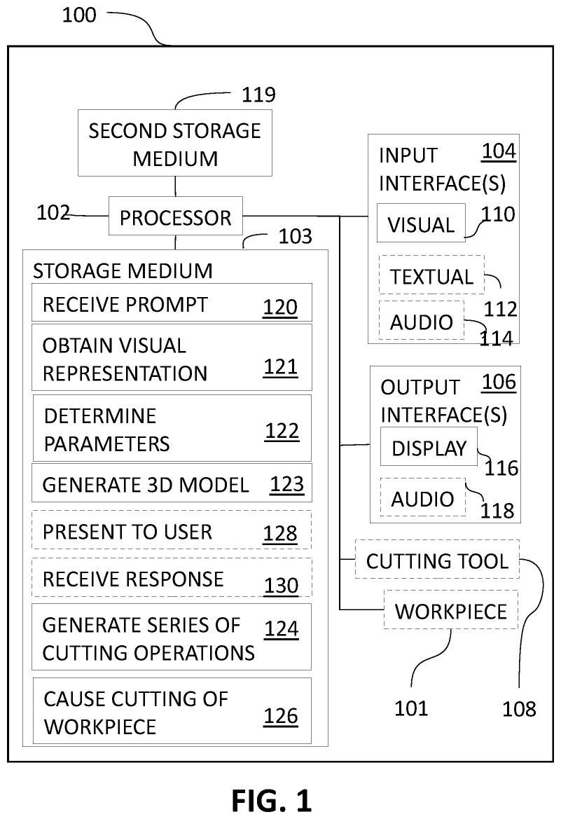

FIG. 1 is a block diagram of a system 100 for cutting into a workpiece 101, for example to form a desired part, in accordance with an embodiment of the disclosed technology.

As seen, system 100 includes a processor 102, functionally associated with a storage medium 103, such as a non-transitory computer readable storage medium, storing instructions for operation of the processor. Processor 102 is further associated with one or more input interfaces 104, an output interface 106, and a cutting tool 108.

Input interface(s) 104 typically includes a visual input interface 110, such as camera or a mechanism for providing an image to the system. Visual input interface 110 is also functionally associated with the cutting tool 108, such as by being adapted to capture images of the cutting tool and the surrounding work surface, during operation thereof. Input interface(s) 104 may also include a textual input interface 112 and/or an audio input interface 114. In some embodiments, the textual input interface 112 may include a keyboard and/or a mouse, touchscreen, or touchpad associated with a virtual keyboard running on the processor. In some embodiments, the audio input interface may include a microphone and associated software for receiving audio input from the user.

In some embodiments, the output interface 106 includes a display 116, such as a screen. In some embodiments, the output interface 106 may include an audio output interface, such as a speaker 118.

In addition to storing instructions for operation of processor 102, storage medium 103 may further store training data, such as data relating or correlating text to three-dimensional models described by the text. In some embodiments, the training data may be stored in a second storage medium 119, such as a database, functionally associated with processor 102 and/or with storage medium 103.

In some embodiments, cutting tool 108 forms part of system 100. In some embodiments, cutting tool 108 is external to system 100, and is adapted to be associated with processor 102 and with visual input interface 110.

In some embodiments, workpiece 101 forms part of system 100. In other embodiments, the system is adapted to modify workpiece 101, but the workpiece does not form part of the system.

As mentioned, storage medium 103 stores instructions to be executed by processor 102. In some embodiments, storage medium 103 stores:
instructions 120 to receive an instructional prompt from the user;
instructions 121 to obtain a visual representation of the workpiece, for example from the visual input interface 110;
instructions 122 to determine at least one parameter of the workpiece relative to cutting tool 108, based on the visual representation of the workpiece;
instructions 123 to generate a three-dimensional model of the part to be cut from the workpiece, based on the received instructional prompt, the visual representation of the workpiece, and the training data; and
instructions 124 to generate, based on the three-dimensional model and parameters of the workpiece relative to cutting tool 108, a cutting routine to be carried out on the workpiece to cut the desired part, the cutting routine including a series of machining operations, for example suitable for Computer-Aided Manufacturing (CAM); and
instructions 126 to cause cutting tool 108 to cut workpiece 101, based on the generated series of machining operations, to form the desired part.

In some embodiments, storage medium 103 may further have stored instructions 128, to be executed following execution of instructions 122 and prior to execution of instructions 126, to visually output the three-dimensional model to the user, and to receive from the user a response to the visual output.

In some embodiments, the response may be a confirmation of the visually output three-dimensional model. In other embodiments, the response may be, or may include, an additional instructional prompt for updating of the three-dimensional model.

In some embodiments, storage medium 103 may further have stored instructions 130, to be executed following receipt of the additional instructional prompt, for updating the three-dimensional model in accordance with the additional instructional prompt.

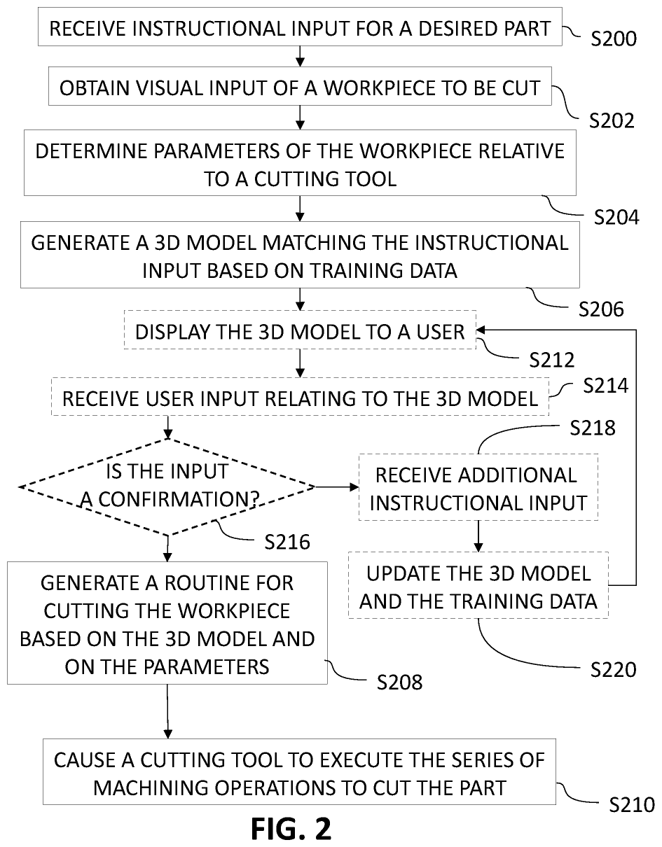

FIG. 2 is a flowchart of a method of cutting into a workpiece in accordance with an embodiment of the disclosed technology, for example using system 100 of FIG. 1.

At step S200, processor 102 receives an instructional prompt for cutting a desired part out of a specific workpiece, for example by executing instructions 120. The instructional prompt may be textual prompt, for example provided via textual user interface 112, or an audio prompt, for example provided via audio user interface 114.

In some embodiments, the instructional prompt may include a description of a shape to be cut, such as a polygon or an irregularly shape polygon. For example, the instructional prompt may specify a number of sides or faces of the polygon, angles between such faces, and/or dimensions of one or more of the faces.

In some embodiments, the instructional prompt may specify at least one physical property or visual feature of the workpiece, and a task to be performed with respect to the physical property or visual feature. For example, the instructional prompt may specify that the shape to be cut should not include a crack present in the workpiece.

In some embodiments, the instructional prompt may include a description of a first real-world object, a linguistic modifier, and a style of a second real-world object, for fabricating a part of the described first real-world object in accordance with the style of the second real-world object. For example, the instructional prompt may specify “cut a box having a base similar to a Staunton chess piece”, with the process leading to instructions for cutting, from the workpiece, a box including base bevels which match, in their depth or shape, to bevels in the specified type of chess pieces. Stated differently, the instructional prompt may specify a desire for a unique version of the first real-world object, embodied in the style of the second real-world object.

In some embodiments, the instructional prompt may include limitations relating to the capabilities of the cutting tool. For example, the instructional prompt may specify a cutting depth, a flexibility in cutting depth, and/or a corner radius that the cutting tool can achieve. In some embodiments, the instructional prompt may include a specification of the cutting tool that will be used for cutting (e.g., cut using a 3-axis Avid cnc router with a 4HP spindle).

At step S202, processor 102 obtains a visual representation of the workpiece to be cut, for example by executing instructions 121. In some embodiments, the visual representation may include one or more two-dimensional images. In some embodiments, the visual representation may include a three-dimensional scan. In some embodiments, the visual representation may include a video.

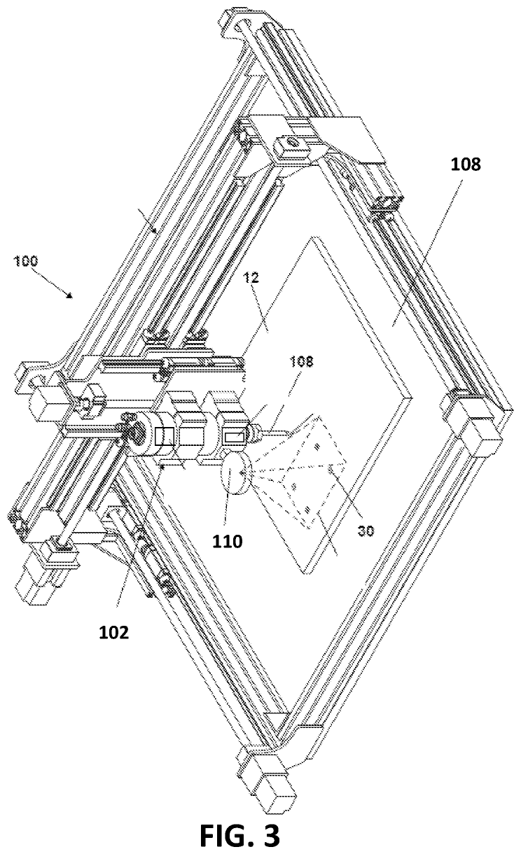

In some embodiments, the visual representation may include one or more glyphs visible on a side of the workpiece, for example as illustrated in FIG. 3. FIG. 3 shows visual input interface 110, in the form of a camera, disposed above a workpiece 12, and capturing an image of the workpiece including multiple glyphs or markers 30. In the embodiment shown in FIG. 3, workpiece 101 is disposed within cutting tool 108, and is in communication with processor 102, so that images captured by camera 110 are transmitted to processor 102, for example via a suitable network interface.

In some embodiments, the glyph(s) may be disposed on a guide, temporarily placed over the workpiece, for example as described in U.S. Pat. No. 11,853,031 to the same inventor, which is incorporated herein by reference.

At step S204, processor 102 determines parameters of workpiece 101 relative to cutting tool 108, for example by executing instructions 122. The parameters may include any one or more of a location of the workpiece relative to the cutting tool, a size of the workpiece, a shape of the workpiece, and/or a location of a visual feature or a physical property of the workpiece. For example, a visual feature may include a pattern formed in the grain of a wooden workpiece, or a specific area in the grain of the wooden workpiece. A physical property may include the location, shape, and/or dimensions of a crack or a break in the workpiece.

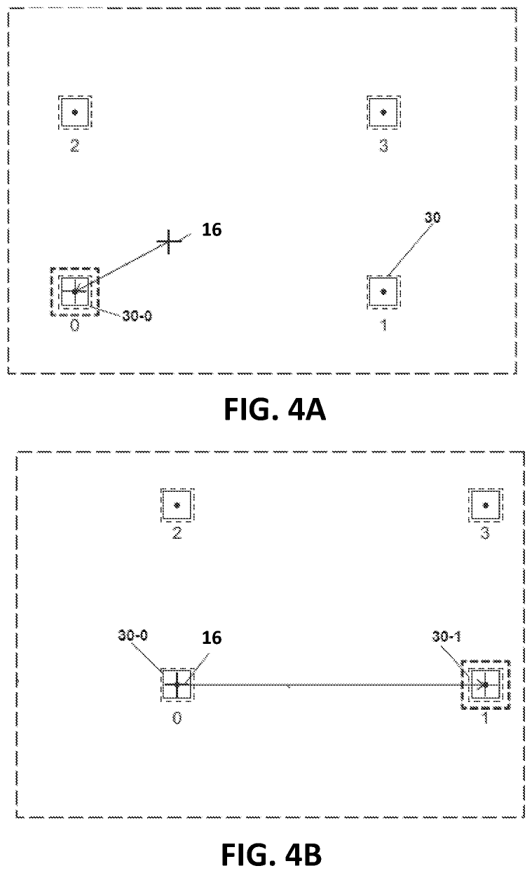

In some embodiments, the determination of the location of the workpiece relative to the cutting tool includes providing a location of the first glyph and the second glyph relative to a cutting tool to the input interface 106, for example as described in in U.S. Pat. No. 11,609,550 and in in U.S. Pat. No. 11,583,031, both of which are incorporated herein by reference. For example, as shown in FIGS. 4A and 4B, the cutting tool may be guided to each of the glyphs, as indicated by cross 16 representing an active end of the cutting tool being guided to glyphs 14. Input interface 104, such as camera 110 thereof or three-dimensional sensor (e.g. accelerometer) may detect, or identify, the position of the cutting tool relative to the glyph(s).

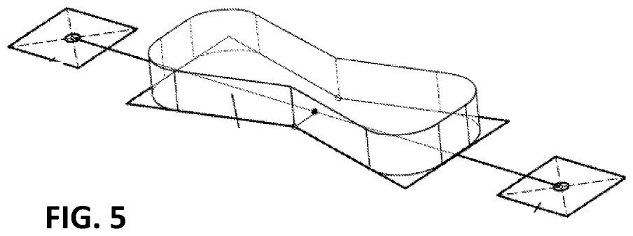

At step S206, processor 102 generates a three-dimensional model matching the instructional prompt, for example by executing instructions 123. The three-dimensional model is typically generated based on training data, previously stored in storage medium 104 and/or in second storage medium 119. In some embodiments, the three-dimensional model may be generated relative to the parameters of the workpiece, such as the model representing a specific area or portion of the workpiece. FIG. 5 illustrates and exemplary three-dimensional model, disposed between two glyphs of the workpiece, such that the location of the three-dimensional model relative to the workpiece may be clearly established.

In some embodiments, the three-dimensional model is generated, in part, based on prior CAM tool paths used for cutting previous workpieces, for example stored in the training data. In some such embodiments, the three-dimensional-model is based on a determined relationship between the instructional prompt and a previous input prompt, the previous input prompt being associated with the cutting of the previous workpieces. For example, the instructional prompt may specify cutting of a 0.05″ deep slot using a 0.25″ down-spiral router bit. If such instructions are also provided in a previous input prompt, then the CAM tool paths generated for cutting the previous workpiece may similarly be used, or assumed, when generating the three-dimensional model.

At step S208, which occurs subsequently to step S206, processor 102 generates a cutting routine for cutting the workpiece, for example by executing instructions 124. Typically, the cutting routine is based on the three-dimensional model generated at step S206, and on the parameters determined at step S204. Typically, the cutting routine includes CAM instructions, such as g-code instructions, to be executed by the cutting tool. Subsequently, at step S210, processor 102 causes cutting tool 108 to execute the cutting routine, thereby to cut the workpiece to fabricate the desired part. For example, step S210 may be accomplished by processor 102 executing instructions 126.

In some embodiments, following generation of the three-dimensional model at step S206 and prior to generation of the cutting routine at step S208, the user has the opportunity to confirm or correct the generated three-dimensional model.

In some such embodiments, following step S206 and prior to step S208, at step S212 processor 102 provides a visual output of the generated three-dimensional model to the user, for example on display 118. For example, step S212 may be carried out by the processor executing instructions 128. In some embodiments, the visual output may include a version of the visual input of the workpiece to be cut. In some embodiments, the visual output may include a rendering of the workpiece following cutting thereof.

At step S214 processor 102 receives a user input relating to the visual output provided to the user, for example via user interface(s) 104. For example, step S214 may be carried out by the processor executing instructions 130. For example, the user input may be a text provided via textual interface 112, or may be an audio input provided via audio interface 114.

At step S216, processor 102 evaluates the received user response, to determine whether it includes a confirmation of the visual input provided to the user (and of the three-dimensional model). If at step S216 processor 102 determines that the input is a confirmation, indicating that the user finds acceptable the three-dimensional model that was displayed to him/her, flow continues to step S208 for generation of the cutting routine for fabricating the part corresponding to the three-dimensional model.

Otherwise, if at step S216 processor 102 determines that the user response does not include a confirmation, at step S218 processor 102 receives additional instructional prompt, further clarifying or specifying the task the user wishes to carry out, or otherwise correcting the previously generated three-dimensional model. For example, the additional instructional prompt may include one or more manipulation operations to be carried out on the three-dimensional model, such as an alteration of one or more of orientation, scale, reflection, translation, dilation, and/or position of the three-dimensional model or of a portion thereof. As another example, the additional instructional prompt may include one or more modification operations to be carried out on the three-dimensional model, such as an alteration of the shape of the three-dimensional model or of a portion thereof, such as by changing a number of sides or faces of the object, angular relationships between sides and faces, or the like.

At step S220, processor 102 updates the three-dimensional model in accordance with the instructions provided as part of the additional instructional prompt. In some embodiments, processor 102 may also update the training-data stored in storage medium 103 and/or in second storage medium 119 based on the additional instructional prompt. Subsequently, the flow returns to step S210 at which a visual output of the updated three-dimensional model is presented to the user, and proceeds iteratively from there until the user confirms the three-dimensional model and the workpiece is cut.

In an example of carrying out the steps described above with reference to FIGS. 1 to 5, “conditional generation” is used which is defined as placing conditions or limitations on the end result along with iterative machine learning based on acceptance/rejection by a human user of proposed changes to objects in the physical world. Such acceptance/rejection by a human user is referred to herein as “iterative” machine learning. The system integrates conditional generation with a parametrization framework, allowing users to input design preferences and constraints for part manufacturing. A generative AI model generates initial design parameters or options, which the user can refine through iterative feedback. This process ensures that the final design is optimized for the specific requirements, including material selection, dimensions, tooling, and machining parameters. This invention resolves a major drawback typical of generative AI models, constraining their wildest capabilities to conform with the precise geometric tolerances necessary to produce precisely manufactured parts. The generated parameters cover aspects of the manufacturing process, including any one of, or a combination of, material type, tool selection, feed rates, and spindle speeds. Each parameter is defined in a standardized format, allowing for clear specification and adjustment.

Users interact with the system by reviewing the generated parameters and providing feedback or adjustments based on their specific needs or constraints. This iterative process allows for the refinement of parameters, with the AI model dynamically updating the generated outputs to reflect the user's feedback. The process continues until the user approves the final parameters, at which point the system finalizes the design for manufacturing.

By way of example, in the prior art of artificial intelligence generation, when one asks, for example, “draw a 12-toothed gear” the prior art output might actually be a gear with the wrong number of teeth, an irregularly shaped gear, or not a gear at all. With conditional generation, a person places the conditions or limitations to what the model is supposed to create along with iterative machine learning” where the process is iteratively refined. By treating “number of teeth” as a parameter, the user may then input the parameter value “12” to assert the exact desired output.

A “condition” is defined as a movement routine which must be within the resultant artificial intelligence generation based on instructions provided.

A “limitation” is defined as a shape of a resultant part or physical product designed to be, or created based on, the input description into the artificial intelligence procedures.

Conditional generation can be provided by the AI model such as a set of typed parameters which are iterated based on each of the typed parameters and values until a solution matching the conditions and limitations placed on the resultant physical object. The physical object can be any physical object described in the specification. In embodiments of the disclosed technology, the parameters, limitations, or conditions (or combinations thereof) include visual “glyphs” with associated real-world positions as determined by moving a camera or other visual input devices around a workpiece to be acted upon.

An example follows._

Iterative Process Step 1: The artificial intelligence proposes typed key-value parameters, default values, and a range of values based indirectly on human input, as described in the following example python model code: :
class ProgramParameter (Model):
name=models. CharField (max_length=255, null=False, default=“Parameter”)
type=models. CharField (max_length=16, null=False, default=“String”)
value=models.CharField (max_length=255, null=True)
unit=models.CharField (max_length=16, null=False, default=“Unit”)
description=models.CharField (max_length=255, null=False,
default=“Description”)
help_text=models.CharField (max_length=255, null=False, default=“Help Text”)
max_value=models.FloatField (null=True)
min_value=models.FloatField (null=True)
default value=models.BooleanField (default=Fa, null=False)
parameter_type=models.CharField (max_length=25, null=False, default=“Project”)

In the following example, instructions to generate a set of custom coasters, engraved with Staunton-style chess pieces, is developed. The parameters as presented might be (this example as provided by OpenAI's “GPT-4” large language model):
1. Shape:
   name: “Coaster Shape”
   type: “Choice”
   value: “Circular|Square|Wavy”
   unit: “N/A”
   description: “The shape of the coaster”
   help_text: “Select the shape of the coaster. Choices include Circular, Square, or Wavy.”
   parameter_type: “Project”
2. Size (Diameter for Circular Coaster, Side Length for Square, Outer Dimension for Wavy):
   name: “Coaster Size”
   type: “Number”
   value: “4.0”
   unit: “inches”
   description: “Size of the coaster depending on the chosen shape”
   help_text: “Standard size is 4.0 inches. Adjust based on preference and coaster shape.”
   max_value: “6.0”
   min_value: “3.5”
   parameter_type: “Project”
3. Thickness:
   name: “Coaster Thickness”
   type: “Number”
   value: “0.5”
   unit: “inches”
   description: “Thickness of the coaster”
   help_text: “Recommended thickness for stability and durability.”
   max_value: “1.0”
   min_value: “0.25”
   parameter_type: “Project”
4. Design Detail:
   name: “Engraving Design Detail”
   type: “Choice”
   value: “Pawn|Knight|Bishop|Rook|Queen|King”
   unit: “N/A”
   description: “Design to be engraved on the coaster”
   help_text: “Select which Staunton chess piece to engrave. Choices include Pawn, Knight, Bishop, Rook, Queen, King.”
   parameter_type: “Project”

The iterative process then proceeds allowing a person to edit the parameters, as needed. The user might change a center point or edge point in a coordinate plane, for example. The Coaster may then be parameterized with a “shape”, “size”, “thickness”, and choice of “Design Detail,” after which output machining code (e.g. GCode) is generated. The iterative process then proceeds again with yet another iteration based on the output of the AI model from the new input from the prior conditional generation.

In the next embodiment a two dimensional sketch may be provided, such as an engraved Staunton chess piece (in this example) in grayscale showing depth based on shading, and a CAD (computer aided drafting) library for dimensional element input. The AI model generation can continue until the sketch has desired characteristics, such as the size, area, shape and so on, in this case, the circular diameter and circumference of a top planar circular side of a coaster. Such can be represented by python code: Bore (CoasterCenter, diam=3.5, d=0.75). One skilled in the art can write further code for scaling depth, changing machining parameters (such as spindle speed, described above), and the like to create a more particular piece of desired qualities. With the final parameters set, the system translates the design into GCode or equivalent commands for CNC machines or other manufacturing equipment. This step considers the specified tool paths, material properties, and machining parameters to ensure the part is produced accurately and efficiently.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods, systems, and devices described herein-above are also contemplated and within the scope of the disclosed technology.

I claim:

1. A method for fabricating a part from a workpiece using a cutting tool, the method comprising the steps of:
a. receiving a first instructional prompt describing a desired part to be fabricated;
b. obtaining visual input of the workpiece to be cut;
c. using the visual input, determining a location, size, and shape of the workpiece relative to the cutting tool;
d. generating a three-dimensional model matching the description in the first instructional prompt, based on previously obtained training data;
e. generating a cutting routine based on the three-dimensional model and on the determined location, size, and shape of the workpiece relative to the cutting tool; and
f. causing execution of the cutting routine so as to cut workpiece to fabricate the desired part.

2. The method of claim 1, further comprising, following step d and prior to step e, visually outputting a representation of the three-dimensional model to a user.

3. The method of claim 2, further comprising, following the visually outputting and prior to said generating a cutting routine:
receiving from the user a second instructional prompt including instructions for altering the three-dimensional model; and
based on the second instructional prompt, altering at least one of the three-dimensional model and the training data.

4. The method of claim 1, wherein the receiving at step a comprises receiving the first instructional prompt as a text input.

5. The method of claim 1, wherein the receiving at step a comprises receiving the first instructional prompt as an audio input.

6. The method of claim 1, wherein the obtained visual input includes at least one glyph, and the determining of the location of the workpiece relative to the cutting tool is based on the location of the at least one glyph.

7. The method of claim 1, wherein the cutting routine comprises a cutting routine which is neither explicit in the training data nor explicit in the first instructional prompt.

8. The method of claim 1, wherein:
the first instructional prompt comprises a description of a first real-world object with a linguistic modifier comprising a style of a second real-world object;
the generating of the three-dimensional model comprises generating a three-dimensional model which is a unique version of the first real-world object in the style of the second real-world object; and
the desired part resulting from cutting by the cutting tool comprises a representation of the unique version of the first real-world object.

9. The method of claim 1, wherein the first instructional prompt comprises a description of a visual feature of the workpiece and a task to be performed on, or relative to, the visual feature of the workpiece.

10. The method of claim 9, wherein the visual feature is a crack or a break in the workpiece, and the task to be performed comprises fixing of the craft or the break in a manner described in the first instructional prompt.

11. The method of claim 9, wherein the task to be performed comprises preparing of the workpiece to interface with a second workpiece or part.

12. A system for cutting a workpiece using a cutting tool, the system comprising:
a visual input interface;
at least one other input interface;
a data storage medium storing training data;
a processor, functionally associated with the visual input interface, the at least one other input interface, and the data storage medium; and
an instructions storage medium, storing instructions for operation of the processor, the instructions storage medium having stored:
a. instructions to receive from the at least one other input interface a first instructional prompt describing a desired part to be fabricated, and to receive from the visual input interface a visual input of the workpiece to be cut;
b. instructions to use the received visual input to determine a location, size, and shape of the workpiece relative to the cutting tool;
c. instructions to generate a three-dimensional model matching the description in the first instructional prompt, based on the training data;
d. instructions to generate a cutting routine based on the three-dimensional model and on the determined location, size, and shape of the workpiece relative to the cutting tool; and
e. instructions to cause the cutting tool to execute the cutting routine so as to cut workpiece to fabricate the desired part.

13. The system of claim 12, further comprising an output interface, functionally associated with the processor, the instructions storage medium further having stored instructions for the processor to provide, via the output interface, a visual output of the three-dimensional model, the visual output being perceivable by a user.

14. The system of claim 13, wherein the instructions storage medium further has stored:
instructions to receive from the user a second instructional prompt including instructions for altering the three-dimensional model provided in the visual output; and
instructions to alter at least one of the three-dimensional model and the training data based on the second instructional prompt.

15. The system of claim 12, wherein the at least one other input interface comprises at least one of:
a textual interface adapted to capture the first instructional prompt as a text input; and
an audio interface adapted to capture the first instructional prompt as an audio input.

16. The system of claim 12, wherein the visual input includes at least one glyph, and the instructions to determine of the location of the workpiece relative to the cutting tool comprise instructions to determine the location based on the location of the at least one glyph.

17. The system of claim 12, wherein the instructions to generate the cutting routine comprise instructions to generate a cutting routine which is neither explicit in the training data nor explicit in the first instructional prompt.

18. The system of claim 12, wherein:
the first instructional prompt comprises a description of a first real-world object with a linguistic modifier comprising a style of a second real-world object; and
the instructions to generate the three-dimensional model comprise instructions to generate a three-dimensional model which is a unique version of the first real-world object in the style of the second real-world object.

19. The system of claim 12, further comprising the cutting tool.
